(19) United States
(12) Patent Application Publication
(10) Pub. No.: US 2017/0032318 A1
(43) Pub. Date: Feb. 2, 2017

(54) UNMANNED POSTAL ACCEPTANCE/RECEPTION APPARATUS AND UNMANNED POSTAL ACCEPTANCE/SUBMISSION/RECEPTION METHOD THEREOF

(71) Applicant: Electronics and Telecommunications Research Institute, Daejeon (KR)

(72) Inventors: Moon Sung PARK, Daejeon (KR); Jin Hyoung PARK, Cheongju-si Chungcheongbuk-do (KR)

(21) Appl. No.: 15/171,699

(22) Filed: Jun. 2, 2016

(30) Foreign Application Priority Data
Jul. 27, 2015 (KR) 10-2015-0105834

(51) Int. Cl. G06Q 10/08

(52) U.S. Cl. CPC G06Q 10/0836; G06Q 10/0833

(57) ABSTRACT

An unmanned postal acceptance/reception apparatus includes: a web application server configured to acquire and transmit acceptance information association data from a mobile terminal, transmit a submission request of a selected postal mail and submission completion data, or transmit a reception request of a selected postal mail and reception completion data; a postal logistics information manager configured to receive and register the acceptance information association data, or receive a result of the submission request of the postal mail or the reception request of the postal mail from the web application server; an operation manager configured to acquire postal mail acceptance/submission/reception result information from the postal logistics information manager, and provide the acquired postal mail acceptance/submission/reception result information to the postal logistics information manager; and a postal mail acceptance/reception integrated controller configured to generate the postal mail acceptance/submission/reception result information, and provide the postal mail acceptance/submission/reception result information to the operation manager.

### CROSS-REFERENCE TO RELATED APPLICATION

The present application claims priority under 35 U.S.C. §119(a) to Korean patent application number 10-2015-0105834 filed on Jul. 27, 2015 in the Korean Intellectual Property Office, the entire disclosure of which is incorporated herein by reference.

### BACKGROUND

1. Field

An aspect of the present disclosure relates to a postal automation system, and more particularly, to an unmanned postal acceptance/reception apparatus and an unmanned postal acceptance/submission/reception method thereof.

2. Description of the Related Art

Various postal automation systems have existed until now. However, in the postal automation systems, procedures performed by checking weights, volumes, and numbers of accepted postal mails are not efficient, and therefore, it is very difficult to accept post matters due to complicated authentication procedures.

Also, in the postal automation systems, complicated procedures are required when people receive their postal mails at the same time or when receivers are authenticated, and therefore, it is very difficult to receive postal mails.

Accordingly, it is required to develop an unmanned postal acceptance/reception apparatus that enables efficient acceptance and reception of postal mails.

### SUMMARY

Embodiments provide an unmanned postal acceptance/reception apparatus which enables efficient acceptance and reception of postal mails through a mobile terminal.

Embodiments also provide an unmanned postal acceptance/reception apparatus which can simplify an acceptance procedure of a postal mail.

Embodiments also provide an unmanned postal acceptance/reception apparatus which enables acceptance of a postal mail with only a simple acceptance information input or address input through a mobile terminal.

Embodiments also provide an unmanned postal acceptance/reception apparatus which efficiently provides a postal acceptance and reception procedure even when another person uses the unmanned postal acceptance/reception apparatus.

According to an aspect of the present disclosure, there is provided an unmanned postal acceptance/reception apparatus, including: a web application server configured to acquire and transmit acceptance information association data associated with address information according to request data including an acceptance registration request of postal mails, a submission information request of non-submitted postal mails, or a reception information request of delivered postal mails from a mobile terminal, transmit a submission request of a selected postal mail and submission completion data by providing details of the non-submitted postal mail, or transmit a reception request of a selected postal mail and reception completion data by providing details of the delivered postal mails; a postal logistics information manager configured to receive and register the acceptance information association data, or receive a result of the submission request of the postal mail or the reception request of the postal mail from the web application server; an operation manager configured to acquire postal mail acceptance/submission/reception result information corresponding to the request data by using data received from the postal logistics information manager, and provide the acquired postal mail acceptance/submission/reception result information to the postal logistics information manager; and a postal mail acceptance/reception integrated controller configured to generate the postal mail acceptance/submission/reception result information corresponding to the request data, and provide the postal mail acceptance/submission/reception result information to the operation manager.

The web application server may include: an address information management module configured to manage address information; a postal mail simple acceptance module configured to communicate with the mobile terminal, and receive, from the mobile terminal, information related to postal mail acceptance information, address selection, and acceptance registration; an association data generation/management module configured to generate acceptance information association data by associating an address selected through the address selection with the postal mail acceptance information; a code generation module configured to generate the acceptance information association data as a bar cord or QR code, and output the bar code or QR code to the mobile terminal through the postal mail simple acceptance module; and a postal logistics information association module configured to output the acceptance information association data to the postal logistics information manager.

The unmanned postal acceptance/reception apparatus may further include a postal mail submission/reception control management module configured to inquire non-submitted postal mail information and postal mail delivery information according to the acceptance of a postal mail through the postal logistics information association module, and output, to the postal mail simple acceptance module, the non-submitted postal mail information and the postal mail delivery information, acquired through the inquiry. The postal mail simple acceptance module may output the non-submitted postal mail information and the postal mail delivery information according to a request of the non-submitted postal mail information and the postal mail delivery information from the mobile terminal.

The association data generation/management module may encode the postal mail acceptance information and the address information.

The postal logistics information manager may include: a postal logistics information management control module configured to receive the acceptance information association data through the mobile terminal, and provide the mobile terminal or the operation manager with postal logistics information corresponding to the acceptance information association data; and a data management module configured to store unmanned postal acceptance/delivery integrated management data, acceptance procedure and acceptance information association data, and unmanned postal acceptance/reception device management data through control of the postal logistics information management control module, or output, to the postal logistics information management control module, data corresponding to a request of the postal logistics information management control module.

The operation manager may include: a postal logistics information interface configured to transmit/receive information related to postal mails to/from the postal logistics information manager; a postal mail delivery/reception management module configured to manage postal mail delivery information and postal mail reception procedure information the postal logistics information interface; a postal mail acceptance/submission management module configured to manage acceptance request information according to the acceptance information association data and postal mail acceptance result information corresponding to the acceptance request information through the postal logistics information interface; and a postal logistics information management module configured to provide the postal mail reception integrated controller with the postal mail delivery information, the postal mail reception procedure information, and the reception request information, and output the postal mail acceptance result information to the postal logistics information interface.

The postal mail acceptance/reception integrated controller may include: a reading module configured to acquire postal mail acceptance information generated through the mobile terminal according to postal mail acceptance; an acceptance information acquisition management module connected to the reading module to manage the postal acceptance information; a measurement module configured to acquire postal mail information according to the postal mail acceptance; a payment module configured to provide a charging service according to the postal mail acceptance; a postal mail acceptance management module connected to the measurement module and the payment module to provide the postal mail information and the charging service; a postal mail common acceptance and storage box configured to store postal mails therein; and a postal mail common acceptance and storage box management module configured to manage states and opening/closing operations of the postal mail common acceptance and storage box.

The reading module may include: a near field communication (NFC) reader configured to acquire the postal mail acceptance information through NFC; and a code reader configured to acquire the postal mail acceptance information by reading a bar code or QR code.

According to an aspect of the present disclosure, there is provided an unmanned postal acceptance method of an unmanned postal acceptance/reception apparatus, including: receiving a postal mail acceptance information registration request from a mobile terminal; providing the mobile terminal with address data according to the postal mail acceptance information registration request; generating acceptance information association data according to selection of the address data from the mobile terminal; after the acceptance information association data is generated, transmitting, to the mobile terminal, a bar code, a QR code, or NFC data, generated based on the acceptance information association data; if the bar code, the QR code, or the NFC data is received from the mobile terminal, generating or acquiring acceptance information through acceptance information registration or previous acceptance information inquiry; and outputting a label and a receipt through charge payment, based on the acceptance information.

The generating of the acceptance information association data may include encoding and generating the acceptance information association data in a predetermined encoding manner.

The receiving of the postal mail acceptance information registration request may include receiving information obtained by selecting one of acceptance information generation and previous acceptance. Information on a sender and a receiver may be received when the acceptance information generation is selected, and information on a kind of postal mails, a receiver, and a number of postal mails may be received when the previous acceptance is selected.

According to an aspect of the present disclosure, there is provided an unmanned postal submission/reception method of an unmanned postal acceptance/reception apparatus, including: receiving, through a mobile terminal, selection of a place in which an unmanned postal mail common acceptance and storage box is located and postal mail submission and reception; inquiring and outputting postal mail information corresponding to the postal mail submission and reception; determining whether a postal mail common acceptance and storage box management module is to control the postal mail common acceptance and storage box; and outputting, to the mobile terminal, whether the postal mail common acceptance and storage box management module is to control the postal mail common acceptance and storage box, and opening the postal mail common acceptance and storage box according to a postal mail common acceptance and storage box opening request.

The method may further include, when the postal mail common acceptance and storage box management module is not to control the postal mail common acceptance and storage box, providing the mobile terminal with information on a use state of the postal mail common acceptance and storage box.

The method may further include, when the postal mail common acceptance and storage box management module is not to control the postal mail common acceptance and storage box, providing the mobile terminal with information on an available sequence of the postal mail common acceptance and storage box and an available time of the postal mail common acceptance and storage box.

The method may further include, when the state of the postal mail common acceptance and storage box is changed to an available state, providing the mobile terminal with information on the available state of the postal mail common acceptance and storage box.

The method may further include, if the information on submission and reception completion of a postal mail is received from the mobile terminal, changing the state of the corresponding postal mail to a submission and reception completion state and registering the submission and reception completion state.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a postal automation system according to an embodiment of the present disclosure.

FIG. 2 is a diagram illustrating a mobile terminal according to an embodiment of the present disclosure.

FIG. 3 is a diagram illustrating a web application server according to an embodiment of the present disclosure.

FIG. 4 is a diagram illustrating a postal logistics information manager according to an embodiment of the present disclosure.

FIG. 5 is a diagram illustrating an operation manager according to an embodiment of the present disclosure.

FIG. 6 is a diagram illustrating a postal mail acceptance/reception integrated controller according to an embodiment of the present disclosure.

FIG. 7 is a flowchart exemplarily illustrating a procedure of registering postal mail acceptance information in the mobile terminal according to an embodiment of the present disclosure.

FIG. 8 is a flowchart illustrating an operation in which an unmanned postal acceptance/reception apparatus measures a weight and a volume of a postal mail and then acquires and transmits information generated from the mobile terminal through the postal logistics information manager according to an embodiment of the present disclosure.

FIG. 9 is a flowchart illustrating a procedure of accepting a postal mail using a previous input result in the mobile terminal and the unmanned postal acceptance/reception apparatus according to an embodiment of the present disclosure.

FIG. 10 is a flowchart illustrating a procedure of submitting and receiving a delivered postal mail in the mobile terminal and the unmanned postal acceptance/reception apparatus according to an embodiment of the present disclosure.

### DETAILED DESCRIPTION

Hereinafter, exemplary embodiments of the present disclosure will be described in detail with reference to the accompanying drawings. In the following description of the present disclosure, a part necessary for understanding an operation according to the present disclosure will be described, and a detailed description of known functions and configurations incorporated herein will be omitted when it may make the subject matter of the present disclosure rather unclear.

The present disclosure provides an unmanned postal acceptance/reception apparatus capable of efficiently providing acceptance and reception of postal mails through a mobile terminal. The mobile terminal may transmit/receive information related to acceptance or reception of a postal mail to/from the unmanned postal acceptance/reception apparatus by using a mobile web application that allows a procedure related to the acceptance or reception of the postal mail to be previously performed.

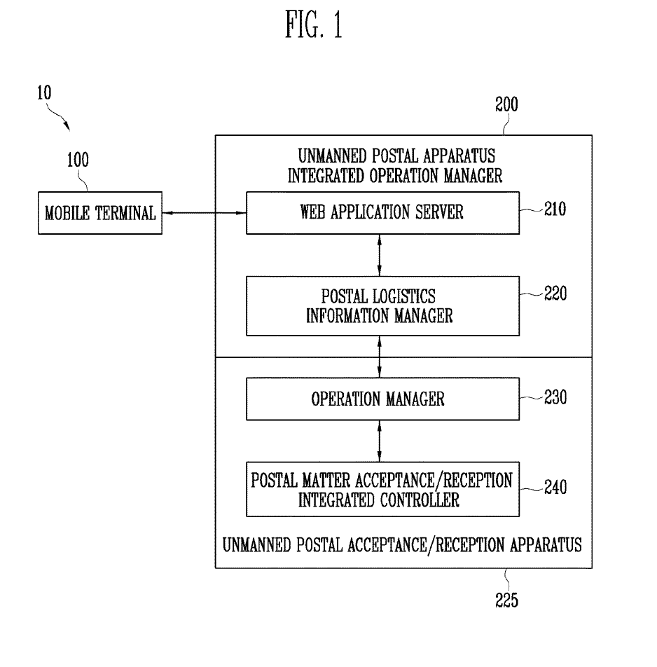

FIG. 1 is a diagram illustrating a postal automation system according to an embodiment of the present disclosure.

Referring to FIG. 1, the postal automation system 10 includes a mobile terminal 100, an unmanned postal apparatus integrated operation manager 200, and an unmanned postal acceptance/reception apparatus 225. Here, one mobile terminal 100 operating together with the unmanned postal apparatus integrated operation manager 200 and the unmanned postal acceptance/reception apparatus 225 is shown for convenience of illustration, and two or more mobile terminals may operate together with the unmanned postal apparatus integrated operation manager 200 and the unmanned postal acceptance/reception apparatus 225.

The mobile terminal 100 includes all user devices capable of providing communication functions, such as a smart phone, a tablet personal computer (PC), and a personal digital assistant (PDA). The mobile terminal 100 may perform, together with the unmanned postal apparatus integrated operation manager 200, procedures including postal mail acceptance information previous input, a directory content selection, acceptance procedure registration, etc. through a web application.

The mobile terminal 100 transmits, to the unmanned postal apparatus integrated operation manager 200, address selection information, etc. for generating acceptance information association data in response to a signal for postal mail acceptance, etc., input from a user. The acceptance information association data may be data associated with address information provided through the unmanned postal apparatus integrated operation manager 200.

The unmanned postal apparatus integrated operation manager 200 includes a web application server 210 and a postal logistics information manager 220. The unmanned postal acceptance/reception apparatus 225 includes an operation manager 230 and a postal mail acceptance/reception integrated controller 240.

If postal mail acceptance information registration from the mobile terminal 100 is requested, the web application server 210 provides, to the mobile terminal 100, data for generating acceptance information association data with which address information is associated. The web application server 210 receives, from the mobile terminal 100, address selection information, etc. for generating acceptance information association data. The web application server 210 acquires acceptance information association data associated with address information selected by the mobile terminal 100, and transmits the acquired acceptance information association data to the postal logistics information manager 220. If submission information on non-submitted postal mails is requested from the mobile terminal 100, the web application server 210 provides details of the non-submitted postal mails and transmits submission request and submission completion data of a selected postal mail to the postal logistics information manager 220. If reception information on delivered postal mails is requested from the mobile terminal 100, the web application server 210 provides details of the delivered postal mails and exchanges reception request and reception completion data of a selected postal mail with the postal logistics information manager 220.

The postal logistics information manager 220 may receive and register acceptance information association data, store postal logistics information including the acceptance information association data, and manage the stored information. Here, the postal logistics information may include unmanned postal acceptance/delivery integrated management data, acceptance procedure and acceptance information association data, unmanned postal acceptance/reception device management data, etc. The postal logistics information manager 220 may receive postal mail submission request and reception request results and transmit the results to the operation manager 230. Also, the postal logistics information manager 220 may manage control data corresponding to acceptance or reception of postal mails, output through the operation manager 230. The postal logistics information manager 220 transmits postal logistics data requested from the web application server 210 or the operation manager 230, and stores postal logistics data received from the web application server 210 or the operation manager 230.

The operation manager 230 acquires postal mail acceptance/submission/reception result information corresponding to request data including an acceptance registration request of a postal mail, a submission information request of a non-submitted postal mail, or a reception information request of a delivered postal mail by using postal logistics information provided through the postal logistics information manger 220. Also, the operation manager 230 provides the acquired postal mail acceptance/submission/reception result information to the postal logistics information manager 220. Also, the operation manager 230 may provide the postal logistics information manger 220 with acceptance information request and acquisition results acceptance corresponding to information association data and information related to postal mail delivery/reception.

The postal mail acceptance/reception integrated controller 240 generates postal mail acceptance/submission/reception result information corresponding to postal mail acceptance/submission/reception requests, and provides the generated postal mail acceptance/submission/reception result information to the operation manager 230. The operation manager 230 provides postal mail acceptance result information to the postal logistics information manager 220. The postal mail acceptance/reception integrated controller 240 may generate postal mail acceptance result information by acquiring measurement results including a number, a weight, a volume, etc. of accepted postal mails. Also, the postal mail acceptance/reception integrated controller 240 may have a function of controlling opening/closing operations of a postal mail common acceptance and storage box for received postal mails, and the like.

As described above, the web application server 210, the postal logistics information manager 220, the operation manager 230, and the postal mail acceptance/reception integrated controller 240, which are included in the unmanned postal apparatus integrated operation manager 200 and the unmanned postal acceptance/reception apparatus 225, may be implemented to be included in one unmanned postal acceptance/reception apparatus 225, or may be implemented as individual devices separated from each other so as to perform their individual functions.

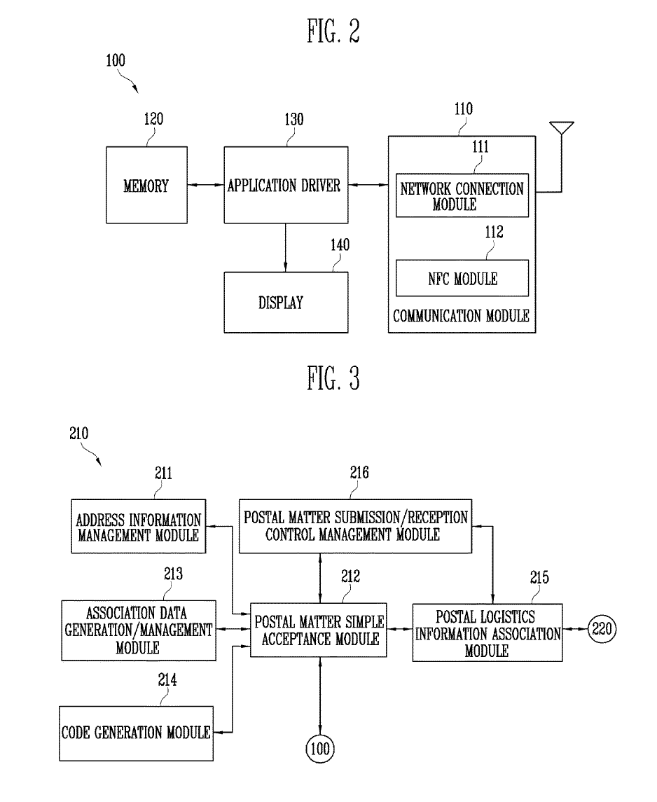

FIG. 2 is a diagram illustrating a mobile terminal according to an embodiment of the present disclosure.

Referring to FIG. 2, the mobile terminal 100 includes a communication module 110, a memory 120, an application driver 130, and a display 140.

The communication module 110 transmits/receives data and has a function of communicating with the unmanned postal apparatus integrated operation manager 200. The communication module 110 includes a network connection module 111 and a near field communication (NFC) module 112.

The network connection module 111 provides a communication function for connection to a mobile communication network (or Internet). The network connection module 111 may communicate with the unmanned postal apparatus integrated operation manager 200 through the mobile communication network.

The NFC module 112 provides near field communication, and enables near field communication with the unmanned postal apparatus integrated operation manager 200.

The memory 120 stores an operation program for operating the mobile terminal 100 and data generated during the operation of the mobile terminal 100. In this case, the memory 120 may store application data for unmanned postal acceptance/reception in the mobile terminal 100.

The application driver 130 may drive application data stored in the memory 120 as a user control signal is input. The application driver 130 may select data (e.g., address information, etc.) for generating acceptance information association data through a postal mail acceptance procedure, and receive a bar code or QR code corresponding to the acceptance information association data as the selected data is provided to the unmanned postal apparatus integrated operation manager 200. The application driver 130 outputs a bar code or QR code to the display 140. Here, the bar code or QR code may be used to simplify an acceptance procedure corresponding to postal mail previous acceptance.

If an input signal (or a user control signal) for postal mail acceptance is generated as an application is driven, the application driver 130 generates information related to the postal mail acceptance and outputs the generated information to the unmanned postal apparatus integrated operation manager 200 through the communication module 110. Also, if an input signal (or a user control signal) for a postal mail acceptance request is generated, the application driver 130 outputs postal common acceptance/delivery box opening information to the unmanned postal apparatus integrated operation manager 200 through the communication module 110. Also, as postal mail acceptance or postal mail reception is made, the application driver 130 may receive information to be provided to a user from the unmanned postal apparatus integrated operation manager 200 through the communication module 110. The application driver 130 may be implemented through a central processing unit (CPU), a processor, etc.

The display 140 may output data generated during an operation of the mobile terminal 100. The display 140 may display application driving information corresponding to unmanned postal acceptance/reception, which is driven by the application driver 130, and may display a bar code or QR code.

The mobile terminal 100 may additionally include, as an example for inputting a user control signal, components such as an input unit including a button, a keypad, a touch pad, etc., but the components are omitted for convenience of illustration.

FIG. 3 is a diagram illustrating a web application server according to an embodiment of the present disclosure.

Referring to FIG. 3, the web application server 210 includes an address information management module 211, a postal mail simple acceptance module 212, an association data generation/management module 213, a code generation module 214, a postal logistics information association module 215, and a postal mail submission/reception control management module 216.

The address information management module 211 manages address information including information on receiver's addresses and sender's addresses as postal mails are accepted. The address information management module 211 outputs address information to the postal mail simple acceptance module 212 according to a request of the postal mail simple acceptance module 212.

The postal mail simple acceptance module 212 communicates with the mobile terminal 100 and receives, from the mobile terminal 100, information related to postal mail acceptance information, address selection, and acceptance registration.

The association data generation/management module 213 generates acceptance information association data in association with postal acceptance information and an address selected by the mobile terminal through address selection. The association data generation/management module 213 may perform an encoding operation when the acceptance information association data. The association data generation/management module 213 outputs the generated acceptance information association data to the postal mail simple acceptance module 212.

The code generation module 214 acquires acceptance information association data through the postal mail simple acceptance module 212, and generates the acquired acceptance information association data in the form of a code, e.g., one of a bar code and a QR code. The code generation module 214 outputs the generated bar code or QR code to the mobile terminal 100 through the postal metal simple acceptance module 212. Here, the generated bar code or QR code may be generated in a form capable of identifying data corresponding to an acceptance procedure, data corresponding to input of individual acceptance information, or data corresponding to acceptance of a large number of postal mails.

The postal logistics information association module 215 may be connected to the postal logistics information manager 220 or may communicate with the postal logistics information manager 220. Accordingly, the postal logistics information association module 215 outputs acceptance information association data to the postal logistics information manager 220.

The postal mail submission/reception control management module 216 inquires postal mail delivery information corresponding to postal mail acceptance through the postal logistics information association module 215 connected to the postal logistics information manager 220, and outputs the postal mail delivery information acquired through the inquiry to the postal mail simple acceptance module 212. Accordingly, the postal mail submission/reception control management module 216 allows the postal mail simple acceptance module 212 receiving a request of postal mail submission information from the mobile terminal 100 to provide the postal mail submission information to the mobile terminal 100.

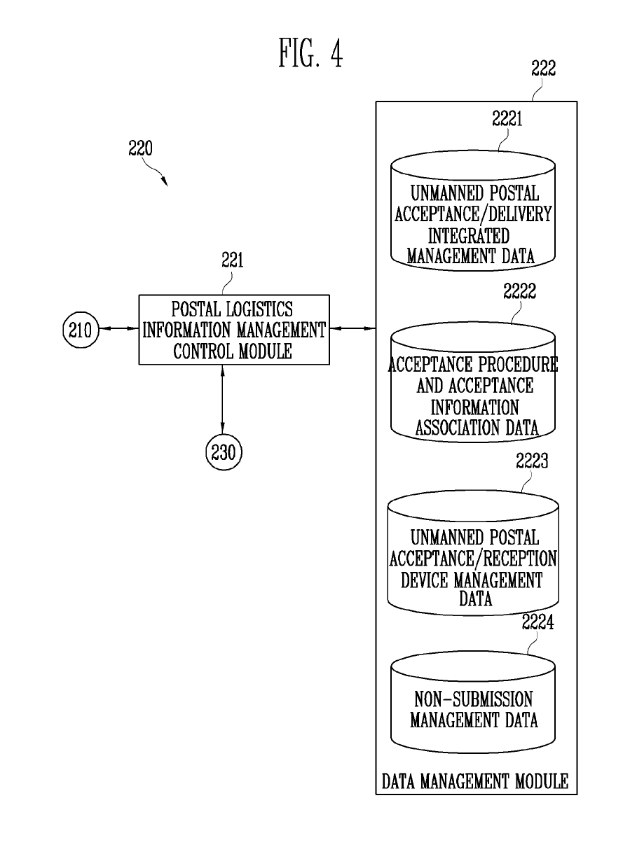

FIG. 4 is a diagram illustrating a postal logistics information manager according to an embodiment of the present disclosure.

Referring to FIG. 4, the postal logistics information manager 220 includes a postal logistics information management control module 221 and a data management module 222.

The postal logistics information management control module 221 may communicate with the web application server 210 or may be connected to the web application server 210. Also, the postal logistics information management control module 221 may communicate with the operation manager 230 or may be connected to the operation manager 230. Accordingly, the postal logistics information management control module 221 stores, in the data management module 222, data input through the web application server 210 or the operation manager 230.

The postal logistics information management control module 221 may register, in the data management module 222, data selected and input from the mobile terminal 100 through a previous postal acceptance procedure.

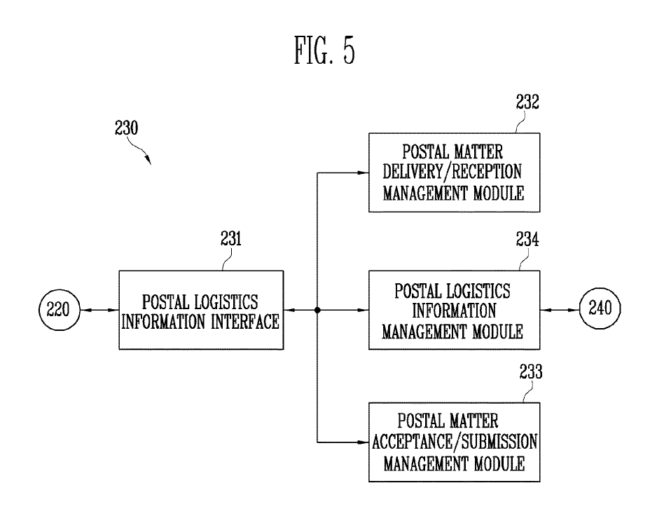

The data management module 222 may be implemented in the form of a storage medium or database. The data management module 222 may store unmanned postal acceptance/delivery integrated management data 2221, acceptance procedure and acceptance information association data 2222, unmanned postal acceptance/reception device management data 2223, and non-submission management data 2224. The unmanned postal acceptance/delivery integrated management data 2221 includes data related to postal mail acceptance for accepting and receiving postal mails and data related to postal mail delivery. The acceptance procedure and acceptance information association data 2222 includes data selected or input by a simple acceptance procedure. The unmanned postal acceptance/reception device control data 2223 includes data for operating the postal mail acceptance/reception integrated controller 240 of FIG. 5 for unmanned postal acceptance/reception. The non-submission management data 2224 includes non-submission data on postal mails to be submitted after a while in an acceptance process, which are selected through the unmanned postal acceptance/reception apparatus 225 of FIG. 1. The non-submission data is provided for the purpose of acceptance in a submission request of the mobile terminal 100, and non-submission data of which acceptance is completed is deleted. The classification and description of data stored in the data management module are illustrative. In addition to the above-described data, the data stored in the data management module may be classified into various data, or may include other data.

The data management module 222 outputs data requested under control of the postal logistics information management control module 221, or stores data input from the postal logistics information management control module 221.

FIG. 5 is a diagram illustrating an operation manager according to an embodiment of the present disclosure.

Referring to FIG. 5, the operation manager 230 includes a postal logistics information interface 231, a postal mail delivery/reception management module 232, a postal mail acceptance/submission management module 233, and a postal logistics information management module 234.

The postal logistics information interface 231 transmits/receives information related to postal mails to/from the postal logistics information manager 220. To this end, the postal logistics information interface 231 outputs data provided to the postal logistics information manager 220 or outputs data provided from the postal logistics information manager 230 to the postal mail deliver/reception management module 232, the postal mail acceptance/submission management module 233, and the postal logistics information management module 234.

The portal matter delivery/reception management module 232 manages postal mail delivery information and reception procedure information through the postal logistics information interface 231.

The postal mail acceptance/submission management module 233 manages acceptance and submission request information corresponding to acceptance information association data and postal mail result information corresponding to the acceptance and submission request information through the postal logistics information interface 231. For example, if data corresponding to an acceptance procedure is received, the postal mail acceptance/submission management module 233 receives results of a weight and a volume, measured from an accepted postal mail, from the postal logistics information management module 234. Accordingly, the postal mail acceptance/submission management module 233 calculates a postal charge and outputs the calculated postal charge to the postal mail acceptance/reception integrated controller 240 through the postal logistics information management module 234.

The postal logistics management module 234 provides the postal mail acceptance/reception integrated controller 240 with postal mail delivery information, postal mail reception procedure information, and acceptance request information, and outputs the postal mail acceptance result information to the postal logistics information interface 231. The postal logistics information management module 234 may manage a control request, control state, or control result, which is requested by the postal logistics information manager 220.

The postal logistics information interface 231 may transmit/receive signals by using data requested there through.

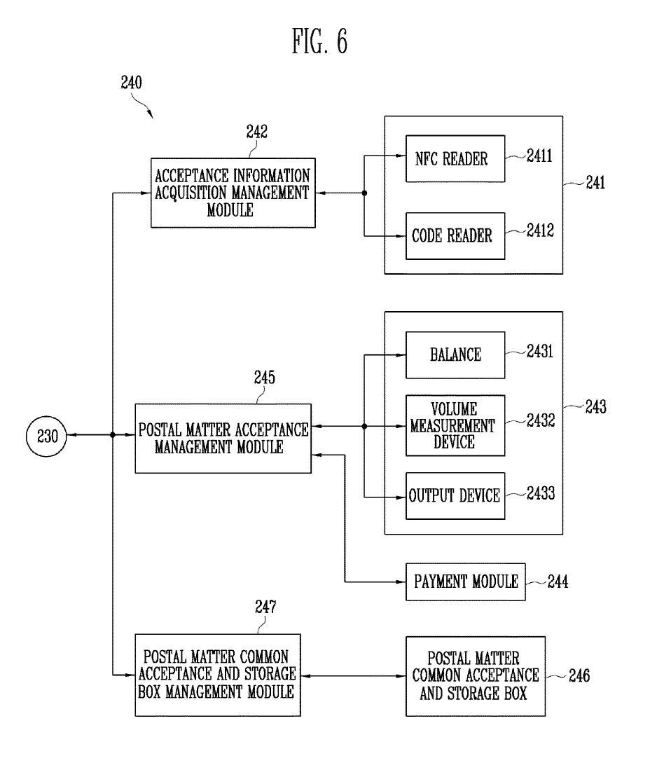

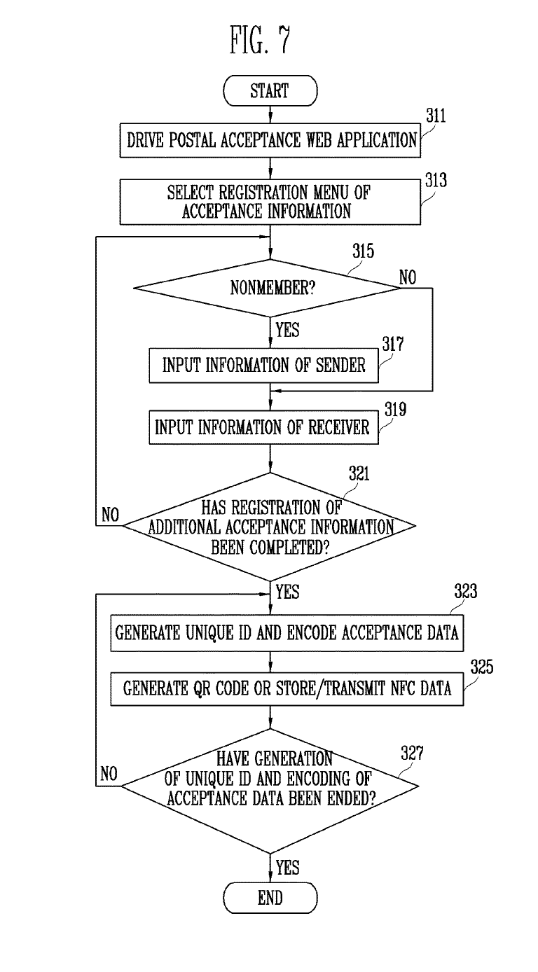

FIG. 6 is a diagram illustrating a postal mail acceptance/reception integrated controller according to an embodiment of the present disclosure.

Referring to FIG. 6, the postal mail acceptance/reception integrated controller 240 includes a reading module 241, an acceptance information acquisition management module 243, a measurement module 243, a payment module 244, a postal mail acceptance management module 245, a postal mail common acceptance and storage box 246, and a postal mail common acceptance and storage box management module 247.

The reading module 241 is a module that acquires postal mail acceptance information generated through the mobile terminal 100 of FIG. 1 according to postal mail acceptance. The reading module 241 includes an NFC reader 2411 and a code reader 2412. The NFC reader 2411 is a non-contact near field communication module, and communicates data with the mobile terminal 100. The code reader 2412 is a reader capable of recognizing a bar code or QR code, and recognizes a bar code or QR code generated in postal mail previous acceptance through the mobile terminal 100.

The acceptance information acquisition management module 242 is connected to the reading module 241, and manages postal mail acceptance information acquired from the mobile terminal 100 through the reading module 241. The acceptance information acquisition management module 242 may provide the acquired postal mail acceptance information to the postal mail acceptance management module 245 or may output the acquired postal mail acceptance information to the operation manager 230.

Also, the acceptance information acquisition management module 242 may perform the general control operations of the postal mail acceptance/reception integrated controller 240. The acceptance information acquisition management module 242 may determine a control order of the NFC reader 2411 or the code reader 2412. The acceptance information acquisition management module 242 may generate a control identification (ID) for performance management and manage a control result.

The measurement module 243 is a module for measuring a weight, volume, etc. of an accepted postal mail. The measurement module 243 includes a balance 2431 and a volume measurement device 2432. The balance 2431 measures a weight of the postal mail, and the volume measurement device 2432 measures a volume of the postal mail.

Also, the measurement module 243 includes an output device 2433 that outputs details of data according a postal mail acceptance procedure and a postal identification label (e.g., including a label, an acceptance voucher, etc. according to postal mail acceptance), a receipt, etc. after the payment of a postal charge corresponding to the measurement of a weight, a volume, etc. is completed through the mobile terminal 100.

The payment module 244 provides a charging service corresponding to postal mail acceptance. The payment module 244 transmits/receives payment information to/from the postal mail acceptance management module 245.

The postal mail acceptance management module 245 is connected to the measurement module 243 and the payment module 244, and receives postal mail information. The postal mail acceptance management module 245 may provide a charging service such as charge payment through transmission/reception of charge related data to/from the payment module 244 according to the postal mail information.

The postal mail common acceptance and storage box 246 may store postal mails accepted to be delivered to others or postal mails delivered to be received from others. The postal mail common acceptance and storage box 246 is opened by permitted users to enable the permitted users to accept or receive postal mails.

The postal mail common acceptance and storage box management module 247 manages states and opening/closing operations of the postal mail common acceptance and storage box 246. The postal mail common acceptance and storage box management module 247 may generate and manage a control order.

Meanwhile, although the unmanned postal acceptance/reception apparatus 225 of FIG. 1 is not shown, the unmanned postal acceptance/reception apparatus 225 may additionally include a display device for inputting or outputting data for postal mail acceptance/reception, an input device (a mouse, a keyboard, a touch pad, a button, etc.), and the like.

A user of the mobile terminal 100 may receive a postal mail by using the unmanned postal acceptance/reception apparatus 225 and drive an Internet post office mobile web application through the mobile terminal 100 to perform a simple acceptance of the postal mail and to inquire a delivery situation of the postal mail. Also, when a receivable postal mail exists, the user of the mobile terminal 100 may receive the postal mail from the unmanned postal acceptance/reception apparatus 225 through a user control input including opening of a postal mail storage box, etc.

The unmanned postal apparatus integrated operation manager 200 of FIG. 1 may confirm a position of the user of the mobile terminal 100 by inputting an identification number of an unmanned post office in which the postal mail storage box is located or inputting a user control signal for selecting the unmanned post office.

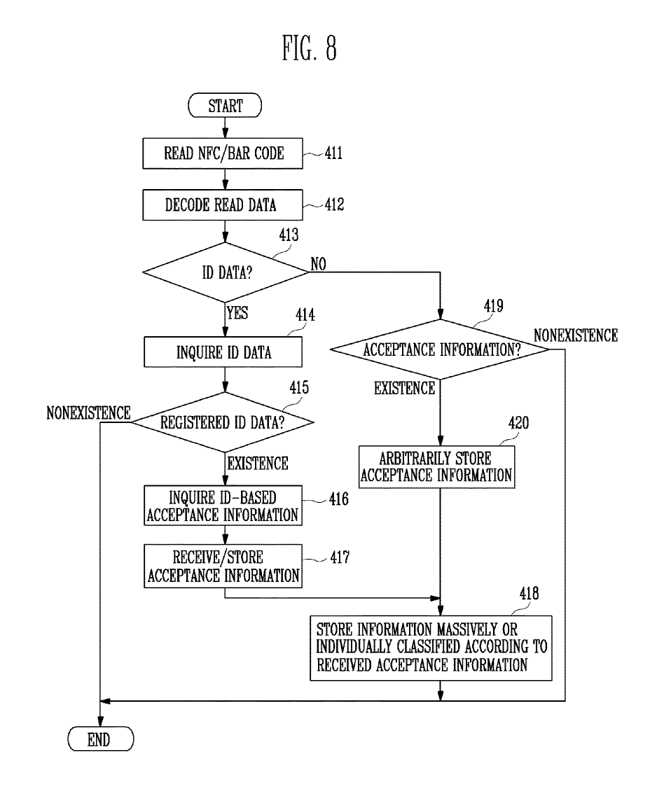

FIG. 7 is a flowchart exemplarily illustrating a procedure of registering postal mail acceptance information in the mobile terminal according to an embodiment of the present disclosure.

Referring to FIG. 7, the mobile terminal 100 of FIG. 1 drives a postal acceptance web application (step 311).

The mobile terminal 100 determines whether the registration of acceptance information of a postal mail has been selected, and proceeds to step 315 (step 313). For example, as the postal acceptance web application is driven, the mobile terminal 100 may additionally perform a log-in operation through an input of an ID, a password, etc. Also, the mobile terminal 100 receives an address identifier of an unmanned post office or receives an unmanned post office inquiry selection signal through an unmanned post office search.

If the registration of the acceptance information is selected as a determination result of step 313, the mobile terminal 100 proceeds to step 315.

The mobile terminal 100 determines whether a sender is a nonmember (step 315). For example, the mobile terminal 100 whether the sender is a member having address information through completion of a procedure such as log in.

If the sender is an unsubscribed member as a determination result of step 315, the mobile terminal 100 proceeds to step 317. Here, the mobile terminal 100 may also determine whether the sender is a currently logged-in user registered in a directory.

When the sender is an unsubscribed member, the mobile terminal 100 inputs information of the sender (e.g., including an address, postal code, name, or contact address of the sender) and proceeds to step 319 (step 317).

If the sender is a member as a determination result of step 315, the mobile terminal 100 proceeds to step 319.

The mobile terminal 100 inputs information of a receiver (e.g., including an address, postal code, name, or contact address of the receiver) and proceeds to step 321 (step 319).

As described in steps 317 and 319, the mobile terminal 100 provides the user to select information of a sender or receiver through the directory, and may select an additional service (e.g., a service such as an overnight express service, a normal service, or a delivery certification service).

The mobile terminal 100 determines whether the registration of additional acceptance information of a postal mail has been completed (step S321).

If a user control signal for registering additional acceptance information of a postal mail is input as a determination result of step 321, the mobile terminal 100 proceeds to step 323.

The mobile terminal 100 generates a unique ID and encodes acceptance data through the unmanned postal apparatus integrated operation manager 200 of FIG. 1, and proceeds to step 325 (step 323).

The mobile terminal 100 generates a QR code (or bar code) corresponding to the acceptance data or stores and transmits NFC data, and proceeds to step 327 (step 325).

The mobile terminal 100 determines whether the generation of the unique ID and the encoding of the acceptance data are to be ended (step 327). Through the encoding, the mobile terminal 100 can acquire information that disables the acceptance data to be illegally copied or used by other unauthorized users.

If the generation of the unique ID and the encoding of the acceptance data are not ended as a determination result of step 327, the mobile terminal 100 proceeds to step 323.

If the generation of the unique ID and the encoding of the acceptance data are ended as a determination result of step 327, the mobile terminal 100 ends the registration of the acceptance information of the postal mail.

The mobile terminal 100 registers an acceptance procedure unique ID and acceptance procedure data in the postal logistics information manager 220 of FIG. 1 and then ends the registration of the acceptance information of the postal mail.

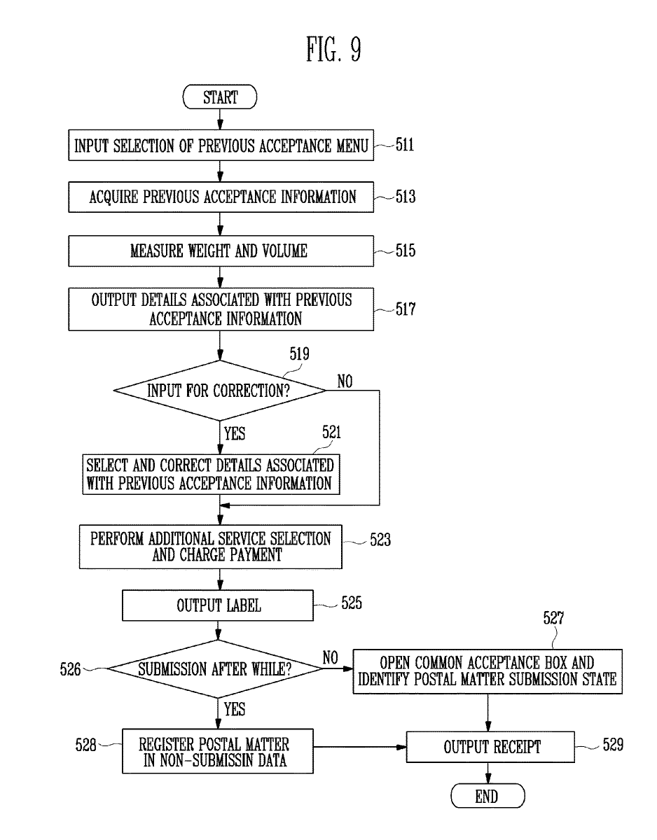

FIG. 8 is a flowchart illustrating an operation in which the unmanned postal acceptance/reception apparatus measures a weight and a volume of a postal mail and then acquires and transmits information generated from the mobile terminal through the postal logistics information manager according to an embodiment of the pre sent disclosure.

Referring to FIG. 8, the unmanned postal acceptance/reception apparatus 225 of FIG. 1 receives and reads a bar code (QR code or ID bar code) or NFC data from the mobile terminal 100 of FIG. 1, and proceeds to step 412 (step 411).

After reading the bar code or the NFC data, the unmanned postal acceptance/reception apparatus 225 decodes the read data, and proceeds to step S413 (S412).

The unmanned postal acceptance/reception apparatus 225 determines whether the read data is ID data (step 413).

If the read data is ID data as a determination result of step 413, the unmanned postal acceptance/reception apparatus 225 inquires the ID data (step 414). The unmanned postal acceptance/reception apparatus 225 determines whether the ID data is registered data (step 415).

If the ID data is registered data as a determination of step 415, the unmanned postal acceptance/reception apparatus 225 proceeds to step 416.

The unmanned postal acceptance/reception apparatus 225 inquiries and acquires ID-based acceptance information from the unmanned postal apparatus integrated operation manager 200 (step 416). At this time, the unmanned postal acceptance/reception apparatus 225 inquires customer acceptance information address data from the acceptance procedure and acceptance information association data 2222 of FIG. 4 in the postal logistics information manager 220 of FIG. 4.

If the read data is not ID data as a determination result of step 413, the unmanned postal apparatus integrated operation manager 200 confirms whether the acquired data is acceptance information (step 419). If the acquired data is acceptance information, the unmanned postal acceptance/reception apparatus 225 arbitrarily stores the acceptance information (step 420) and then ends an operation of transmitting information generated through the mobile terminal 100.

If the ID data is identified as registered data through the determination of step 415, the unmanned postal acceptance/reception apparatus 225 receives information acquired through the acquisition of the ID-based acceptance information (step 416) and stores the received information in an arbitrary storage place (step 417). The unmanned postal acceptance/reception apparatus 225 stores information massively or individually classified according to the received acceptance information and ends the operation of transmitting the information generated through the mobile terminal 100 (step 418).

If the above-described operation is completed, the unmanned postal acceptance/reception apparatus 225 generates a registration number in an address of a receiver among sending information and stores the generated registration number. If the generation of the registration number is completed, the unmanned postal acceptance/reception apparatus 225 calculates a postal charge and outputs the calculated postal charge through a display screen, etc. of the mobile terminal 100 or the unmanned postal acceptance/reception apparatus 225. For example, the postal charge may be calculated based on a postal code of the sender, rest day/holiday setting data, a cut-down rate, details of service selection, etc.

If information corresponding to the completion of charge payment is input, the unmanned postal acceptance/reception apparatus 225 outputs a label or receipt. The label may be attached to a postal mail, and the postal mail may be submitted in the state in which the label is attached thereto through the unmanned postal acceptance/reception apparatus 225.

FIG. 9 is a flowchart illustrating a procedure of accepting a postal mail using a previous input result in the mobile terminal and the unmanned postal acceptance/reception apparatus according to an embodiment of the present disclosure.

Referring to FIG. 9, the mobile terminal 100 receives the selection of a previous acceptance menu, and proceeds to step 513 (step 511). At this time, the mobile terminal 100 performs a procedure except weight or volume measurement and payment, and inputs information for each acceptance screen or stores selected information through the selection of registration. For example, the mobile terminal 100 may store, as a key value, the number of displayed screens and the quantity of postal mails (number of screens-quantity of postal mails) so as to accept two or more postal mails. The mobile terminal 100 may register information acquired by the selection of the previous acceptance menu to the unmanned postal apparatus integrated operation manager 200. Accordingly, the unmanned postal acceptance/reception apparatus 225 can receive a QR code or bar code allocated with a unique ID registered through a postal mail acceptance procedure, data received through NFC transmission, and a unique number.

The mobile terminal 100 acquires previous acceptance information, and proceeds to step 515 (step 513). The mobile terminal 100 inquires previous acceptance information through the unmanned postal apparatus integrated operation manager 200 by reading NFC data, QR code, bar code, etc. or acquiring a previous acceptance unique ID. Thus, the mobile terminal 100 can receive previous acceptance information corresponding to the registration of an acceptance procedure.

The unmanned postal acceptance/reception apparatus 225 measures a weight and a volume of a postal mail for the purpose of acceptance of the postal mail, and proceeds to step 517 (step 515).

After that, if there exists a result obtained by receiving previous acceptance information, the mobile terminal 100 outputs, to the unmanned postal acceptance/reception apparatus 225, the previous acceptance information, i.e., details associated with the previous acceptance information (acceptance information association data associated with address information, and proceeds to step 519 (step 517).

The mobile terminal 100 determines whether an input for correction exists (step 519).

If it is required to correct the previous acceptance information as a determination result of step 519, the mobile terminal 100 proceeds to step 521.

The mobile terminal 100 selects and corrects details associated with the previous acceptance information, and proceeds to step 523 (step 521). The mobile terminal 100 outputs the corrected details to the unmanned postal acceptance/reception apparatus 225.

If it is not required to correct the previous acceptance information as a determination result of step 519, the mobile terminal 100 proceeds to step 523.

The unmanned postal acceptance/reception apparatus 225 perform additional service selection and charge payment, and proceeds to step 525 (step 523).

If the charge payment is completed, the unmanned postal acceptance/reception apparatus 225 outputs a label or printed paper corresponding to the acceptance of the postal mail, and proceeds to step 526 (step 525).

If submission after a while is selected as a submission method after the label is output, the unmanned postal acceptance/reception apparatus 225 registers the postal mail in non-submission data (step 528), and outputs a receipt (step 529). However, submission right now is selected instead of the submission after a while, the unmanned postal acceptance/reception apparatus 225 opens a common acceptance box and identifies a postal mail submission state, and proceeds to step 529 (step 527).

The unmanned postal acceptance/reception apparatus 225 outputs a receipt and ends the acceptance of the postal mail (step 529).

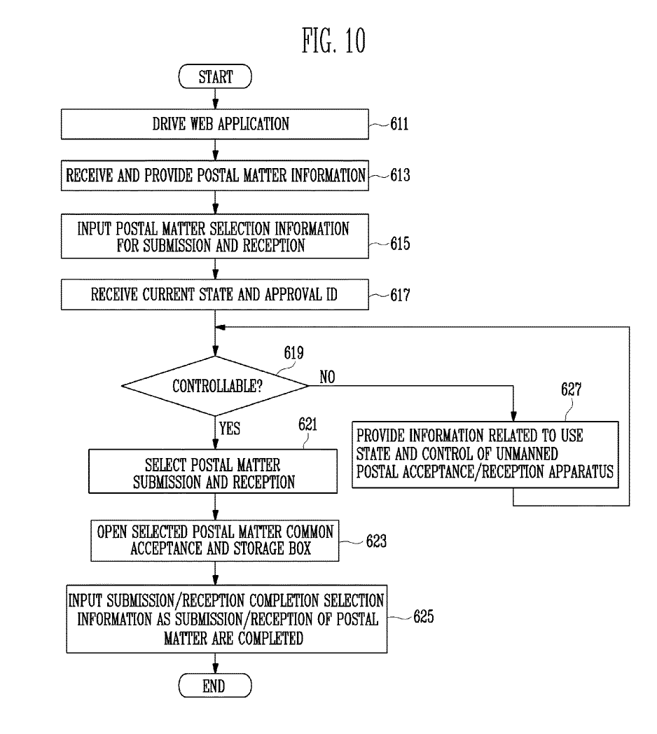

FIG. 10 is a flowchart illustrating a procedure of submitting and receiving a delivered postal mail in the mobile terminal and the unmanned postal acceptance/reception apparatus according to an embodiment of the present disclosure.

Referring to FIG. 10, the mobile terminal 100 drives a web application and proceeds to step 613 (step 611). When a user is subscribed as a member through the driving of the web application, the mobile terminal 100 selectively performs log-in processing as the user inputs an ID and a password. After that, the mobile terminal 100 may select an unmanned post office by receiving an address ID of the unmanned post office or searching for the unmanned post office. Accordingly, the mobile terminal 100 can select a postal mail submission and reception menu.

The mobile terminal 100 receives postal mail information and provides the received postal mail information through the selection of the postal mail submission and reception menu, and proceeds to step 615 (step 613). The postal mail information may include non-submitted postal mail information and delivery postal mail information. The non-submitted postal mail information may be provided by reading a registration bar code or inputting a registration number.

The mobile terminal 100 receives postal mail selection information for submission and reception, and proceeds to step 617 (step 615). After that, the mobile terminal 100 requests the unmanned postal acceptance/reception apparatus 225 to submit or receive a postal mail through the unmanned postal apparatus integrated operation manager 200. For example, the mobile terminal 100 requests a postal mail ID, etc.

The mobile terminal 100 receives a current state and an approval ID from the unmanned postal acceptance/reception apparatus 225, and proceeds to step 619 (step 617). To this end, the mobile terminal 100 may request the unmanned postal apparatus integrated operation manager 200 to approve control of the postal mail common acceptance and storage box management module 247 of FIG. 6 in the postal mail acceptance/reception integrated controller 240 of FIG. 6.

The mobile terminal 100 determines whether the control of the postal mail common acceptance and storage box management module 247 is currently possible (step 619). At this time, the unmanned postal acceptance/reception apparatus 225 provides the postal mail acceptance/reception integrated controller 240 with the postal mail ID selected by the mobile terminal 100 through the postal logistics information manager 220, thereby confirming an available state of the postal mail common acceptance and storage box management module 247. Accordingly, the mobile terminal 100 can identify whether a control request is made in a state in which the postal mail common acceptance and storage box 246 of FIG. 6 is used while acceptance or reception is performed by another customer or while collection or delivery is performed by a postman, through a control system (e.g., the postal mail common acceptance and storage box management module 247) of the postal mail acceptance/reception integrated controller 240.

Meanwhile, if the control request from the mobile terminal 100 is received to the postal mail common acceptance and storage box management module 247 through the operation manager 230, the postal mail common acceptance and storage box management module 247 provides an ID according to the order of priority, in which the control request is made, and may store, together with the provided ID, a current state (used under acceptance, used under reception, used under collection, used under delivery, available, or completion of use), an approval ID, a date (day and time) on which the approval ID is provided, a value of unavailability (e.g., a defect), a requester ID, etc. If the control request is a request from the mobile terminal 100, a control right allocation result and a state value according to the control request may be registered in the postal logistics information manager 220. Thus, the unmanned postal acceptance/reception apparatus 225 sequentially allocates performance of control rights according to the order of priority, in which the control request is made, and allows a control right of the next order to be performed after the performance of a current control right is completed.

When the control of the postal mail common acceptance and storage box management module 247 is possible as a determination result of step 619, the mobile terminal 100 proceeds to step 621. At this time, the postal mail acceptance/reception integrated controller 240 registers, in the postal logistics information manager 220, that the postal mail common acceptance and storage box management module 247 is in an available state (allocates a controllable ID).

The mobile terminal 100 receives a selection signal for selecting postal mail submission and reception, and proceeds to step 623 (step 621). The postal mail common acceptance and storage box management module 247 allows a door of the postal mail common acceptance and storage box 246 to be opened in response to a postal mail submission and reception selection signal.

The mobile terminal 100 requests the unmanned postal acceptance/reception apparatus 225 to open the door of the postal mail common acceptance and storage box 246, and proceeds to step 625 (step 623). Accordingly, a user can submit a non-submitted postal mail and receive a delivered postal mail by opening the door of the postal mail common acceptance and storage box 246. After that, if the door of the postal mail common acceptance and storage box 246 is closed by the user, the unmanned postal acceptance/reception apparatus 200 may identify the state in which the door of the postal mail common acceptance and storage box 246 is closed. After the use of the postal mail common acceptance and storage box 246 is completed, the postal mail common acceptance and storage box management module 247 may control the postal mail common acceptance and storage box 246 to be used for storage of other postal mails. For example, after the use of the postal mail common acceptance and storage box 246 is completed, the postal mail common acceptance and storage box management module 247 may change the state of the postal mail common acceptance and storage box 246 to an available state or initialization state.

When a user waiting for submission and reception is connected to the postal mail common acceptance and storage box management module 247 through the mobile terminal 100, the postal mail common acceptance and storage box management module 247 notifies that the user has logged in the mobile terminal 100, and may change the state of the postal mail common acceptance and storage box 246 to a state in which the user can directly submit a non-submitted postal mail and directly receive a delivered postal mail.

The mobile terminal 100 inputs submission and reception completion selection information as the submission and reception of a selected postal mail are completed, and ends the submission and reception of the postal mail (step 625). Accordingly, the mobile terminal 100 can register, in the unmanned postal apparatus integrated operation manager 200, information on the corresponding postal mail of which submission and reception are completed, through the unmanned postal acceptance/reception apparatus 225. In this case, details of a postal mail of which submission is completed among non-submitted postal mails may be deleted from the non-submission management data.

When the control of the postal mail common acceptance and storage box management module 247 is not possible as a determination result of step 619, the mobile terminal 100 proceeds to step 627. In this case, the mobile terminal 100 may receive information on a state in which the postal mail common acceptance and storage box 246 is used under control of another customer or postman.

The mobile terminal 100 provides the user with information related to a use state and control of the unmanned postal acceptance/reception apparatus 225, and proceeds to step 619 (step 627). The mobile terminal 100 provides state information on the postal mail common acceptance and storage box 246 being used. If the state of the postal mail common acceptance and storage box 246 is changed to an available state, the mobile terminal 100 provides the user with information representing the available state. When the state of the postal mail common acceptance and storage box 246 is changed to the available state, the postal mail acceptance/reception integrated controller 240 registers, in the postal logistics information manager 220, that the postal mail common acceptance and storage box 246 is in the available state (allocates a controllable ID). Also, the mobile terminal 100 may confirm whether the state of the postal mail common acceptance and storage box 246 is changed to the available state according to a retry request from the user.

For example, when the control right of the postal mail common acceptance and storage box management module 247 is used by another user, the mobile terminal 100 may output a message “currently used by another user.” Alternatively, when the control of the postal mail common acceptance and storage box management module 247 is not possible as the control right of the postal mail common acceptance and storage box management module 247 is used by another user, the mobile terminal 100 may provide information on an available sequence of the postal mail common acceptance and storage box 246 and an available time of the postal mail common acceptance and storage box 246. After that, if the mobile terminal 100 reaches the sequence after the use of the control right of the postal mail common acceptance and storage box management module 247 is completed, the unmanned postal acceptance/reception apparatus 225 outputs information on the available state of the postal mail common acceptance and storage box 246 to the mobile terminal 100.

When a postal mail is being received through the mobile terminal 100, the unmanned postal acceptance/reception apparatus 225 may provide the number of control rights waiting to be performed and an expected completion state value according to the control rights waiting to be performed, thereby confirming a postal mail receivable order or time.

The unmanned postal acceptance/reception apparatus 225 may set information on a control right ID of which use is completed to be automatically deleted on the next date.

Accordingly, the unmanned postal acceptance/reception apparatus 225 can accept and submit postal mails, based on automatic association of acceptance information with the mobile terminal 100 and a previously registered acceptance procedure. When acceptance is performed according to the previously registered acceptance procedure, the unmanned postal acceptance/reception apparatus 225 can accept a postal mail through only charge payment, attachment of a label, and submission of the postal mail after a weight, a volume, etc. of the postal mail are measured.

Also, the unmanned postal acceptance/reception apparatus 225 enables a user using the mobile terminal 100 to submit an accepted postal mail and receive a delivered postal mail through a postal mail common acceptance and storage box by directly visiting an unmanned post office at a desired time without any waiting time.

According to the present disclosure, the unmanned postal acceptance/reception apparatus previously provides information related to acceptance, submission, and reception of postal mails through the mobile terminal, thereby enabling efficient acceptance, submission, and reception of postal mails. Also, the unmanned postal acceptance/reception apparatus provides a previous acceptance procedure of postal mails through the mobile terminal, thereby simplifying an acceptance procedure of postal mails. In addition, postal mails can be accepted only by simply inputting acceptance information or addresses. Also, the unmanned postal acceptance/reception apparatus can minimize the time required to wait for acceptance and reception of postal mails even when acceptance, collection, delivery, or reception operations are performed by other persons.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. An unmanned postal acceptance/reception apparatus, comprising:
a web application server configured to acquire and transmit acceptance information association data associated with address information according to request data including an acceptance registration request of postal mails, a submission information request of non-submitted postal mails, or a reception information request of delivered postal mails from a mobile terminal, transmit a submission request of a selected postal mail and submission completion data by providing details of the non-submitted postal mail, or transmit a reception request of a selected postal mail and reception completion data by providing details of the delivered postal mails;
a postal logistics information manager configured to receive and register the acceptance information association data, or receive a result of the submission request of the postal mail or the reception request of the postal mail from the web application server;
an operation manager configured to acquire postal mail acceptance/submission/reception result information corresponding to the request data by using data received from the postal logistics information manager, and provide the acquired postal mail acceptance/submission/reception result information to the postal logistics information manager; and
a postal mail acceptance/reception integrated controller configured to generate the postal mail acceptance/submission/reception result information corresponding to the request data, and provide the postal mail acceptance/submission/reception result information to the operation manager.

2. The unmanned postal acceptance/reception apparatus of claim 1, wherein the web application server includes:
an address information management module configured to manage address information;
a postal mail simple acceptance module configured to communicate with the mobile terminal, and receive, from the mobile terminal, information related to postal mail acceptance information, address selection, and acceptance registration;
an association data generation/management module configured to generate acceptance information association data by associating an address selected through the address selection with the postal mail acceptance information;
a code generation module configured to generate the acceptance information association data as a bar cord or QR code, and output the bar code or QR code to the mobile terminal through the postal mail simple acceptance module; and
a postal logistics information association module configured to output the acceptance information association data to the postal logistics information manager.

3. The unmanned postal acceptance/reception apparatus of claim 2, further comprising a postal mail submission/reception control management module configured to inquire non-submitted postal mail information and postal mail delivery information according to the acceptance of a postal mail through the postal logistics information association module, and output, to the postal mail simple acceptance module, the non-submitted postal mail information and the postal mail delivery information, acquired through the inquiry,
wherein the postal mail simple acceptance module outputs the non-submitted postal mail information and the postal mail delivery information according to a request of the non-submitted postal mail information and the postal mail delivery information from the mobile terminal.

4. The unmanned postal acceptance/reception apparatus of claim 2, wherein the association data generation/management module encodes the postal mail acceptance information and the address information.

5. The unmanned postal acceptance/reception apparatus of claim 1, wherein the postal logistics information manager includes:
a postal logistics information management control module configured to receive the acceptance information association data through the mobile terminal, and provide the mobile terminal or the operation manager with postal logistics information corresponding to the acceptance information association data; and
a data management module configured to store unmanned postal acceptance/delivery integrated management data, acceptance procedure and acceptance information association data, and unmanned postal acceptance/reception device management data through control of the postal logistics information management control module, or output, to the postal logistics information management control module, data corresponding to a request of the postal logistics information management control module.

6. The unmanned postal acceptance/reception apparatus of claim 1, wherein the operation manager includes:
a postal logistics information interface configured to transmit/receive information related to postal mails to/from the postal logistics information manager;
a postal mail delivery/reception management module configured to manage postal mail delivery information and postal mail reception procedure information the postal logistics information interface;
a postal mail acceptance/submission management module configured to manage acceptance request information according to the acceptance information association data and postal mail acceptance result information corresponding to the acceptance request information through the postal logistics information interface; and
a postal logistics information management module configured to provide the postal mail reception integrated controller with the postal mail delivery information, the postal mail reception procedure information, and the reception request information, and output the postal mail acceptance result information to the postal logistics information interface.

7. The unmanned postal acceptance/reception apparatus of claim 1, wherein the postal mail acceptance/reception integrated controller includes:
a reading module configured to acquire postal mail acceptance information generated through the mobile terminal according to postal mail acceptance;
an acceptance information acquisition management module connected to the reading module to manage the postal acceptance information;
a measurement module configured to acquire postal mail information according to the postal mail acceptance;
a payment module configured to provide a charging service according to the postal mail acceptance;
a postal mail acceptance management module connected to the measurement module and the payment module to provide the postal mail information and the charging service;
a postal mail common acceptance and storage box configured to store postal mails therein; and
a postal mail common acceptance and storage box management module configured to manage states and opening/closing operations of the postal mail common acceptance and storage box.

8. The unmanned postal acceptance/reception apparatus of claim 7, wherein the reading module includes:
a near field communication (NFC) reader configured to acquire the postal mail acceptance information through NFC; and
a code reader configured to acquire the postal mail acceptance information by reading a bar code or QR code.

9. An unmanned postal acceptance method of an unmanned postal acceptance/reception apparatus, comprising:
receiving a postal mail acceptance information registration request from a mobile terminal;
providing the mobile terminal with address data according to the postal mail acceptance information registration request;
generating acceptance information association data according to selection of the address data from the mobile terminal;
after the acceptance information association data is generated, transmitting, to the mobile terminal, a bar code, a QR code, or NFC data, generated based on the acceptance information association data;
if the bar code, the QR code, or the NFC data is received from the mobile terminal, generating or acquiring acceptance information through acceptance information registration or previous acceptance information inquiry; and
outputting a label and a receipt through charge payment, based on the acceptance information.

10. The unmanned postal acceptance method of claim 9, wherein the generating of the acceptance information association data includes encoding and generating the acceptance information association data in a predetermined encoding manner.

11. The unmanned postal acceptance method of claim 9, wherein the receiving of the postal mail acceptance information registration request includes receiving information obtained by selecting one of acceptance information generation and previous acceptance,
wherein information on a sender and a receiver is received when the acceptance information generation is selected, and information on a kind of postal mails, a receiver, and a number of postal mails is received when the previous acceptance is selected.

12. An unmanned postal submission/reception method of an unmanned postal acceptance/reception apparatus, comprising:
receiving, through a mobile terminal, selection of a place in which an unmanned postal mail common acceptance and storage box is located and postal mail submission and reception;
inquiring and outputting postal mail information corresponding to the postal mail submission and reception;
determining whether a postal mail common acceptance and storage box management module is to control the postal mail common acceptance and storage box; and
outputting, to the mobile terminal, whether the postal mail common acceptance and storage box management module is to control the postal mail common acceptance and storage box, and opening the postal mail common acceptance and storage box according to a postal mail common acceptance and storage box opening request.

13. The unmanned postal submission/reception method of claim 12, further comprising, when the postal mail common acceptance and storage box management module is not to control the postal mail common acceptance and storage box, providing the mobile terminal with information on a use state of the postal mail common acceptance and storage box.

14. The unmanned postal submission/reception method of claim 12, further comprising, when the postal mail common acceptance and storage box management module is not to control the postal mail common acceptance and storage box, providing the mobile terminal with information on an available sequence of the postal mail common acceptance and storage box and an available time of the postal mail common acceptance and storage box.

15. The unmanned postal submission/reception method of claim 13, further comprising, when the state of the postal mail common acceptance and storage box is changed to an available state, providing the mobile terminal with information on the available state of the postal mail common acceptance and storage box.

16. The unmanned postal submission/reception method of claim 12, further comprising, if the information on submission and reception completion of a postal mail is received from the mobile terminal, changing the state of the corresponding postal mail to a submission and reception completion state and registering the submission and reception completion state.
